(19) United States
(12) Patent Application Publication
(10) Pub. No.: US 2008/0073565 A1
(43) Pub. Date: Mar. 27, 2008

(54) OH radical air sterilization lamp quartz tube casing device

(76) Inventor: Dong-Hyeon Jeon, Seongnam (KR)

Correspondence Address: KEUSEY, TUTUNJIAN & BITETTO, P.C., 20 CROSSWAYS PARK NORTH, SUITE 210, WOODBURY, NY, 11797, US

(21) Appl. No.: 11/705,727

(22) Filed: Feb. 13, 2007

(30) Foreign Application Priority Data
Feb. 13, 2006 (KR) 20-2006-0003936

(51) Int. Cl. G01N 23/00

(52) U.S. Cl. 250/455.11

(57) ABSTRACT

Provided is OH radical air sterilization lamp quartz tube casing device that removes germs and odor from air and decomposes harmful gases contained in the air. The OH radical air sterilization lamp quartz tube casing device can decompose organic and inorganic harmful gases contained in air and remove germs and odor from air. Furthermore, the OH radical air sterilization lamp quartz tube casing device can be used to sterilize water. The OH radical air sterilization lamp quartz tube casing device includes a light emitting unit emitting UV light, a casing enclosing the light emitting unit, a fiber (glass-fiber) carrier wrapped around the casing, a catalyst (TiO₂) plate layer formed on the fiber carrier, and a fixing member fixing the fiber carrier to the casing.

### BACKGROUND OF THE INVENTION

1. Technical Field

The present invention relates to an OH radical (hydroxyl ion or OH⁻) air sterilization lamp quartz tube casing device that removes germs and odor from air and decomposes harmful gases contained in the air, and more particularly, to an OH radical air sterilization lamp quartz tube casing device that decomposes organic and inorganic harmful gases contained in air and destroys germs contained in the air.

2. Description of the Related Art

Human bodies are exposed to various harmful environments such as infections in a hospital via air. For example, human bodies can be infected with bird flu, Severe Acute Respiratory Syndrome (SARS), cold viruses, and tubercle bacillus through air or suffer from air odor. Various efforts have been made to solve these problems. However, human bodies continuously suffer from other environmental problems such as contaminated surroundings and sick house/car syndrome. For this reason, much research is being conducted to find eco-friendly methods for preventing contamination of the environment. For example, an UV-C lamp emitting light having a wavelength of 254 nm is widely used to clean air and water in various fields to protect human health without destroying the environment.

According to a Korean food regulation rule, a UV-C lamp should be used for sterilization at food processing factories and restaurants. However, UV-C light is harmful to human bodies. For example, UV-C light can cause cataracts and destroy DNA of the skin. Furthermore, UV-C light can generate ozone (O₃) when it is used to sterilize air. The ozone has a fish-like smell and can result in harmful effects to the mucous membranes of respiratory organs.

In sterilization methods using a photocatalyst (TiO₂) disclosed in U.S. Pat. Nos. 5,439,652, 5,501,801, and 5,480,524, a granular photocatalyst is used to process water. However, in the disclosed methods, water should be recycled while passing through granular photocatalyst, and sufficient oxygen should be dissolved in the water for sterilization. When sufficient oxygen is not dissolved in the water, air should be forcibly blown into the water for the catalysis operation of the granular photocatalyst. This is inconvenient and increases the complexity of the water processing procedures. Furthermore, when an aquatic precipitation plating method is used, a photocatalyst cannot be firmly plated on a base member. That is, the photocatalyst plate layer can be easily separated from the base member. It is inconvenient to use the photocatalyst plate layer for sterilization, and the structure of a sterilization device made using the aquatic precipitation plating method is complicated and has poor durability.

In addition, since such methods use a closed reaction vessel and complicated equipment, it is inconvenient to use the methods. In another sterilization method, a photocatalyst (e.g., TiO₂ sol) is applied to wallpaper or a construction member to use the photocatalyst for processing a volatile organic compound (VOC). However, in this case, light cannot be properly irradiated to the catalyst applied to the wallpaper or the construction member, resulting in poor catalysis. Therefore, germs and volatile organic gas (VOC) cannot be effectively removed from air.

A sterilization method using a lamp device is disclosed in Korea Utility Model No. 0356532, Korea Utility Model application No. 031139/0381152 filed by the applicant, or U.S. Pat. No. 6,135,838. However, when the disclosed sterilization method is used for a refrigerator or at a food processing factory, the lamp device should be water-proof since its electronic components (e.g., a fluorescent lamp and a ballast stabilizer) can be damaged by contact with moisture. Furthermore, if the fluorescent lamp is broken, broken pieces of the fluorescent lamp can be scattered around. Thus, there is a rule for a glass tube to enclose a fluorescent or UV lamp. Furthermore, when the lamp is replaced with a new one, a fiber coated with photocatalyst should be replaced together with the lamp.

Moreover, when a glass tube is used to protect the lamp in the disclosed sterilization method using a lamp device, since the glass tube prevents air from contacting the lamp, sterilization efficiency decreases. As described above, since the fiber coated with photocatalyst should be replaced together with the lamp when the lamp is replaced with a new one, maintenance costs increase and the environment is unnecessarily compromised. Therefore, there is a need for a sterilization lamp casing device that can be used even in the water without the above-described problems.

### SUMMARY

Accordingly, the present invention is directed to an OH radical air sterilization lamp quartz tube casing device that substantially obviates one or more problems due to limitations and disadvantages of the related art.

An object of the present invention is to provide a photocatalyst UV lamp device that can decompose organic and inorganic gases and destroy microorganisms, germs, and bacteria without causing secondary contamination, e.g., at a food processing factory or refrigerator showcase.

Another object of the present invention is to provide a sterilization lamp casing device having an OH radical sterilization function.

A further object of the present invention is to provide an OH radical air sterilization lamp quartz tube casing device that can decompose harmful gases and has an indirect illumination function.

A still further object of the present invention is to provide an OH radical air sterilization lamp quartz tube casing device in which a photocatalyst plate layer has a large surface area and pores for efficient air sterilization and harmful gas decomposition.

Yet a further object of the present invention is to provide an OH radical air sterilization lamp quartz tube casing device that has a simple structure for decomposing harmful gases.

An even further object of the present invention is to provide an OH radical air sterilization lamp quartz tube casing device that has a structure for simply replacement of an UV lamp. An OH radical air sterilization lamp quartz tube casing device includes a light emitting unit emitting UV light and a casing formed of a quartz tube to enclose the light emitting unit. A fiber carrier is wrapped around the casing. A catalyst plate layer is formed on the fiber carrier and includes pores allowing the passage of air. A fixing member fixes the fiber carrier to the casing.

In other embodiments, the catalyst plate layer may be formed on the fiber carrier using a TiO₂ anatase sol by dipping the fiber carrier into the TiO₂ anatase sol and heat treating the fiber carrier to fix the TiO₂ anatase sol to the fiber carrier. The catalyst plate layer may be formed of at least one material selected from the group consisting of nano silver, nano ceramic sol, SiO₂, WO₃, SnO₂, Fe₂O₃, ZnO, Ag, and Pt.

The light emitting unit may emit UV-A light having a wavelength of between about 320 nm to about 380 nm. 8. The light emitting unit may be a cold cathode fluorescent lamp (CCFL), an external electrode fluorescent lamp (EEFL), a light emitting diode (LED), or fluorescent lamp that emits UV-A light having a wavelength of 365 nm. The light emitting unit may include a CCFL, EEFL, LED, or fluorescent lamp that emits UV-C light having a wavelength of 180 nm to 280 nm. The light emitting unit may emit UV-C light having a wavelength of 254 nm.

The casing may be formed of an acryl tube including a polycarbonate (PC) tube or a polyvinyl chloride (PVC) tube to transmit UV-A light. The fiber carrier may be formed of a polyamide based material. The fiber carrier may be formed on a polyethylene based material.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided an OH radical air sterilization lamp quartz tube casing device including a light emitting unit emitting UV light. A casing encloses the light emitting unit. A fiber (glass-fiber) carrier is fixed to the casing. The fiber is formed of a polyamide based material or a polyethylene based material. The polyamide based material may be Kevlar™, Twaron™, GoldpleX™, or Starbond™, and the polyethylene based material may be Dyneema™, Spectra™, Famostone™, Aristone™, or fiberglass. A photocatalyst plate layer is formed on the fiber carrier. The photocatalyst includes pores admitting the passage of air. A fixing member fixes the fiber carrier to the casing.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a cut-away view illustrating a fiber carrier formed with a photocatalyst plate layer according to the present invention;

FIG. 2 is a perspective view illustrating pores of a photocatalyst plate layer according to the present invention;

FIG. 3 is a perspective view illustrating a lamp device capable of decomposing harmful gases according to the present invention;

FIG. 4 illustrates a textile for a fiber carrier according to the present invention;

FIG. 5 illustrates a photocatalyst plate layer in which oxidation catalyst micro particles are added according to the present invention;

FIG. 6 is sectional view illustrating a lamp device capable of decomposing harmful gases;

FIG. 7 illustrates how a fiber carrier is wrapped around a casing of an UV-A light emitting unit emitting 365 nm wavelength light according to the present invention;

FIG. 8 illustrates how a fiber carrier is fixed to a casing of a light emitting unit according to the present invention;

FIG. 9 illustrates a casing according to an embodiment of the present invention;

FIG. 10 is a graph illustrating decomposition of acetic butylene gas when a light emitting unit emits 254 nm wavelength light to a photocatalyst plate layer;

FIG. 11 is a graph illustrating decomposition of acetic butylene gas when a light emitting unit emits 365 nm wavelength light to a photocatalyst plate layer; and

FIG. 12 is a graph illustrating decomposition of acetic butylene gas when a light emitting unit emits 543 nm wavelength light to a photocatalyst plate layer.

### DETAILED DESCRIPTION OF PREFERRED EMBODIMENTS

Reference will now be made in detail to the preferred embodiments of the present invention, examples of which are illustrated in the accompanying drawings. Wherever possible, the same reference numbers will be used throughout the drawings to refer to the same or like parts.

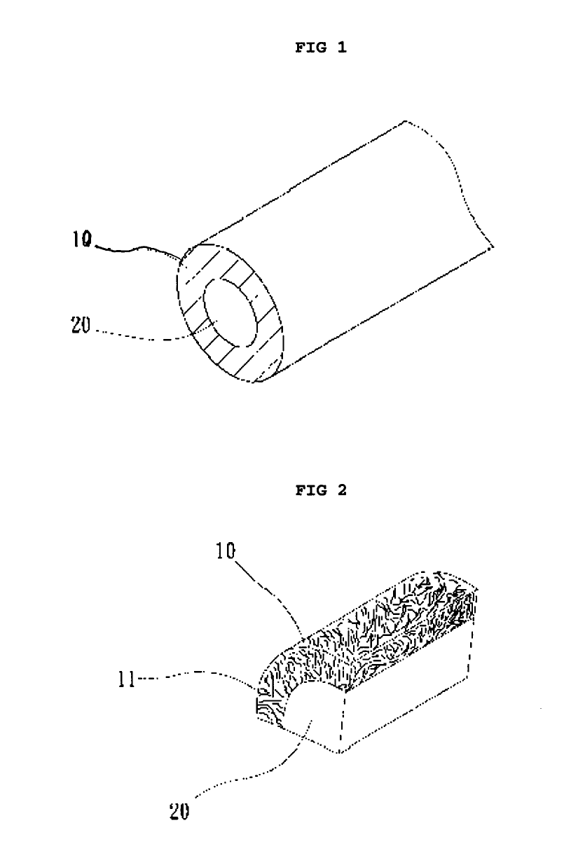

Referring to FIGS. 1 to 3, a lamp device capable of decomposing harmful gases according to an embodiment of the present invention includes a fiber carrier 20 and a photocatalyst plate layer 10 formed on the fiber carrier 20. The photocatalyst plate layer 10 is formed on the fiber carrier 20 by sintering. The photocatalyst plate layer 10 includes pores admitting passage of air. A fixing member 30 is used to fix the fiber carrier 20 to an outside of a casing (glass tube) 50 (FIG. 8) of a light emitting unit 40. When the light emitting unit 40 emits UV-A light toward the photocatalyst plate layer 10, electron and hole pairs are generated to decompose harmful gases and destroy germs by using the OH radical effect.

The fiber carrier 20 may be formed of a fiber-glass yarn or a highly elastic (e.g., up to about 172 Gpa), highly heat-resistive (amide based), and light (ethylene based) yarn having a diameter of 10 to 100 μm and a count of 1 to 100. Hence, owing to tiny apertures of the fiber carrier 20, the photocatalyst plate layer 10 formed on the fiber carrier 20 can receive more air and have a larger surface area. Furthermore, the fiber carrier 20 can include pores 11. Therefore, more air can make contact with the photocatalyst plate layer 10 such that harmful gases included in the air can be easily decomposed and microorganisms contained in the air can be easily removed.

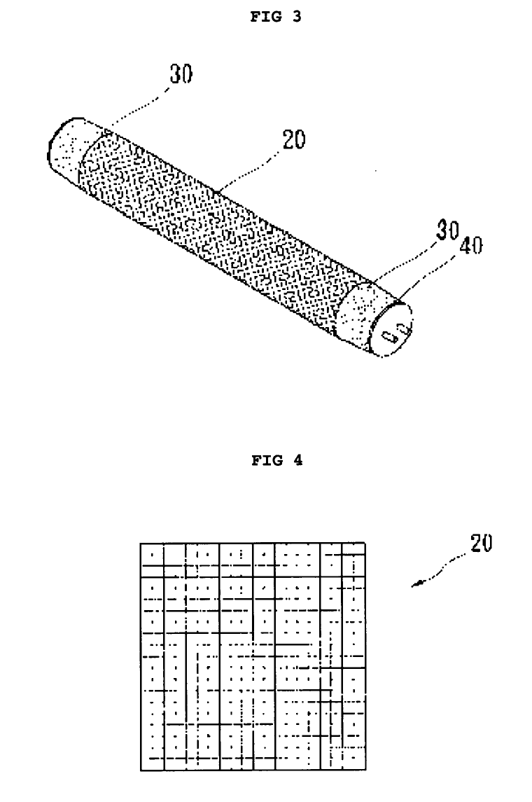

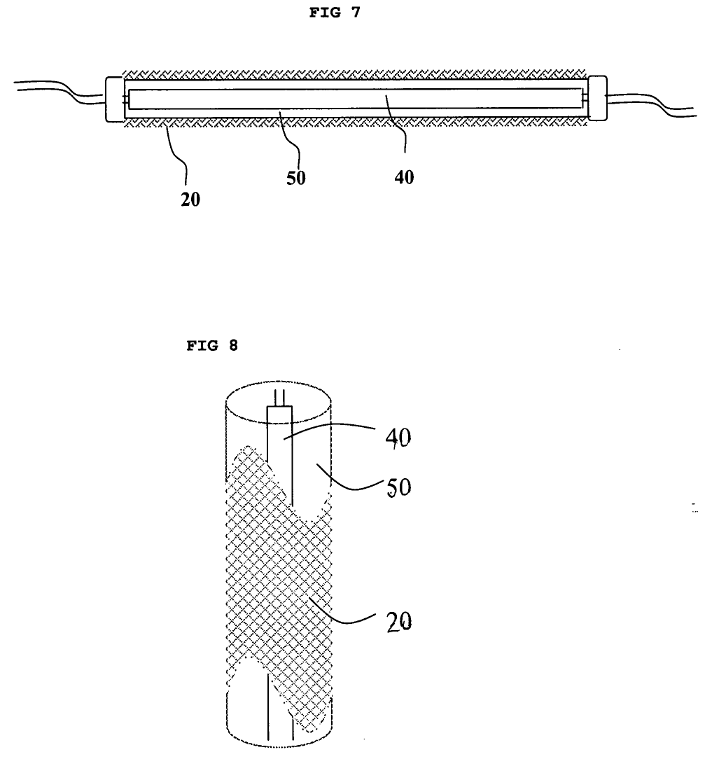

The fiber carrier 20 may have a cylindrical shape (refer to FIGS. 3 and 6) to be fitted around the casing 50 (FIG. 8) that encloses the light emitting unit 40. Alternatively, the fiber carrier 20 can be rolled around the casing 50 (refer to FIGS. 6 and 7) so as to form a plurality of layers around the casing 50. Alternatively, the fiber carrier 20 can have a pouch-like shape (refer to FIG. 8) to be fitted around any shape of the casing 50. The fixing member 30 fixes the fiber carrier 20 to the light emitting unit 40. The fixing member 30 may be formed of a UV-resist material capable of fixing the fiber carrier 20 to the light emitting unit 40 (refer to FIGS. 6 and 7). For example, the fixing member 30 may be formed of a silica gel or glass-cement. After attaching the fiber carrier 20 to an outside of the casing 50, a ring can be used to fix the fiber carrier 20 to the outside of the casing 50 as the fixing member 30. The ring may be formed of a thermoplastic high-molecular material. In this case, when the ring is heated, the ring becomes flexible such that the fiber carrier 20 can be easily fixed to the casing glass tube 50 using the flexible ring.

Referring to FIGS. 3 and 6, the light emitting unit 40 may be an ultraviolet (UV) lamp. The light emitting unit 40 may emit UV-A light or 360 to 380 nm wavelength light. The light emitting unit 40 is fixed inside the casing 50. The fiber carrier 20 can be directly fitted around the light emitting unit 40 or fitted around the casing 50 protecting the light emitting unit 40. The photocatalyst plate layer 10 may include TiO₂. Air can be sterilized after passing through the fiber carrier 20. The photocatalyst plate layer 10 formed on the fiber carrier 20 can adsorb air to decompose harmful gases included in the air and destroy germs. When the light emitting unit 40 is an UV-A lamp emitting 360 to 380 nm wavelength light, UV-A light emitted from the light emitting unit 40 can be sufficiently reached throughout the fiber carrier 20. Thus, the photocatalyst plate layer 10 can absorb the UV-A light. The fiber carrier 20 can be a knit formed of a yarn having a proper count or size, and the knitting density can be properly adjusted so as to introduce air into the photocatalyst plate layer 10 where UV-A light emitted from the light emitting unit 40 is irradiated. Furthermore, in this case, most UV-A light emitted from the light emitting unit 40 can be absorbed by the photocatalyst plate layer 10 and fiber carrier 20.

Referring to FIGS. 2 and 3, the light emitting unit 40 includes a body formed of sodium.calcium.glass, crystal.glass, or boron glass capable of transmitting UV light. The fiber carrier 20 may be formed of an amide based material, a polyethylene based material, or fiberglass that is transparent so as to allow the photocatalyst plate layer 10 to easily absorb UV light emitted from the light emitting unit 40.

In the present invention, instead of enclosing the light emitting unit 40 with the fiber carrier 20, the fiber carrier 20 is wrapped around the casing 50 protecting the light emitting unit 40. That is, the fiber carrier 20 can be easily attached to a sterilization lamp device. Thus, the casing device of the present invention can be easily used for a cup sterilization apparatus, a refrigerator, a refrigerator showcase, an air conditioner, an air cleaner at a restaurant, a food processing factory, a hospital, etc. UV-light can be easily scattered or transmitted through the photocatalyst plate layer 10 formed on the fiber carrier 20 so that air held in the photocatalyst plate layer 10 can be easily sterilized and germs contained in the air can be destroyed. In addition, since the fiber carrier 20 is wrapped around the casing 50 instead of the light emitting unit 40, the light emitting unit 40 can be easily replaced with a new one. Furthermore, since the light emitting unit 40 is designed to have a large surface area, light emitted from the light emitting unit 40 can be irradiated to a larger area of the fiber carrier 20. The photocatalyst plate layer 10 includes pores 11 for admitting passage of air. The photocatalyst plate layer 10 absorbs UV light to facilitate a reaction between water and oxygen for oxidation of organic or inorganic substances contained in air. Furthermore, the photocatalyst plate layer 10 facilitates generation of non-harmful substances such as CO₂ and H₂O. For this, the photocatalyst plate layer 10 can be formed on the fiber carrier 20 by a heat-treatment coating method. In this case, the photocatalyst plate layer 10 can be evenly formed on the fiber carrier 20 without lumps so that the photocatalyst plate layer 10 can have a large surface area like the fiber carrier 20.

In the present invention, a gel fusing method can be used to form the photocatalyst plate layer 10 on the fiber carrier 20. In detail, Ti(OR)₄ (a main material) and an organic salt or mineral are inserted into an alcohol solvent to prepare an organic metal polymer by water-splitting condensation reaction. Furthermore, Ti(OR)₄ is dissolved into an alcohol solvent in a fusing gel state (e.g., TiO₂ anatase sol). A photocatalyst organic salt or mineral such as WO₃, SnO₂, Fe₂O₃, or ZnO is added to the fusing gel. Then, the fiber carrier 20 is dipped into the fusing gel and is taken out of the fusing gel to form the photocatalyst plate layer 10 on the fiber carrier 20. Here, the thickness of the photocatalyst plate layer 10 can be controlled by adjusting the separation speed of the fiber carrier 20 from the fusing gel. Furthermore, the fiber carrier 20 is left in the fusing gel for a predetermined time to allow a water-splitting reaction, and then the fiber carrier 20 is taken out of the fusing gel. After that, the fiber carrier 20 is baked for sintering. In this way, a TiO₂, WO₃, SnO₂, FeO₃, or ZnO photocatalyst layer can be formed as the photocatalyst plate layer 10 on the fiber carrier 20 formed of a polyamide based, polyethylene based, or fiberglass material. In addition, oxidation catalyst micro particles 12 are added into the photocatalyst plate layer 10 to improve decomposition ability of the light emitting unit 40. The oxidation catalyst micro particles 12 may be formed of a precious metal and/or a transition metal. For example, the precious metal may be Pd, Pt, Au, and Ag, and the transition metal may be MoO₃, Nb₂O₅, V₂O₅, CeO₂, and Cr₂O₃.

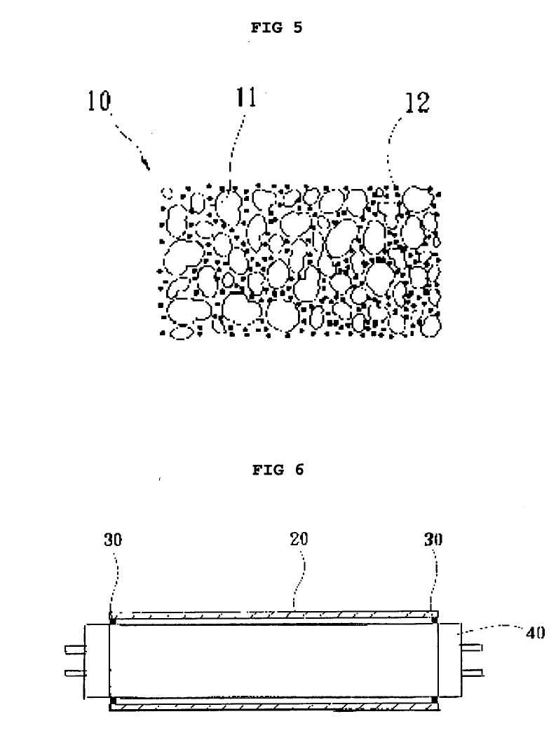

Referring to FIGS. 1, 2, 4, and 5, the fiber carrier 20 formed with the photocatalyst plate layer 10 is inserted into an oxidation catalyst metal salt solution. Since the fiber carrier 20 is porous and the photocatalyst plate layer 10 includes pores 11, the oxidation catalyst metal salt solution can be adsorbed into the fiber carrier 20 and the photocatalyst plate layer 10. Then the fiber carrier 20 is baked. In this way, the oxidation catalyst micro particles 12 are added to the photocatalyst plate layer 10. After that, an activation process is performed on the fiber carrier 20 formed with the photocatalyst plate layer 10, and intensive UV light is irradiated to the photocatalyst plate layer 10 to decompose foreign substances formed on the photocatalyst plate layer 10. Therefore, the photocatalyst plate layer 10 can have a high catalyzing efficiency.

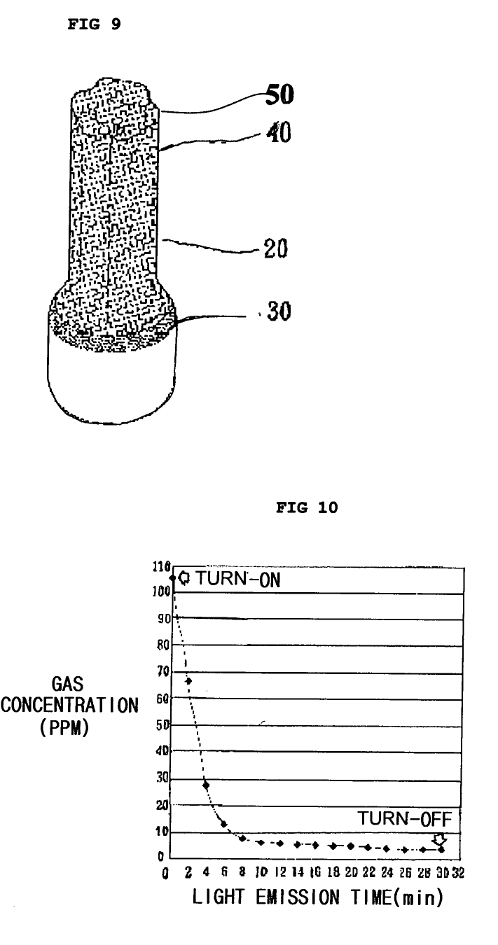

When the fiber carrier 20 is designed to be fitted around the casing 50, the shape of the casing 50 can be freely varied according to the light emitting unit 40. For example, the casing 50 can have a long cylindrical or circular shape (refer to FIG. 9), a pouch-like shape, or a U-shape. When a current is applied to the light emitting unit 40, the light emitting unit 40 emits UV-A light and generates heat. Thus, the temperature of the light emitting unit 40 increases, and air around the light emitting unit 40 flows. The air flows into the photocatalyst plate layer 10 through the pores 11 formed in the photocatalyst plate layer 10. Thus, harmful gases contained in the air can be easily decomposed and gems contained in the air can be easily destroyed. Furthermore, since light emitted from the light emitting unit 40 is UV light with some visible-light component, although the UV light is absorbed by the photocatalyst plate layer 10 and the fiber carrier 20, the visible light component can pass through the photocatalyst plate layer 10 and the fiber carrier 20 for indirect illumination.

Experimental results are shown in FIGS. 10 to 12. For the experiment, the lamp device capable of decomposing harmful gases according to the present invention was placed in a closed space and an acetic butylene gas was injected into the closed space. Then, the lamp device was powered on to emit light having different wavelengths. When the light emitting unit 40 of the lamp device emitted 254 nm wavelength light, the photocatalyst plate layer 10 catalyzes decomposition of the acetic butylene gas as shown in FIG. 10. In FIG. 10, the vertical axis denotes the concentration of acetic butylene gas in ppm, and the horizontal axis denotes light irradiation time in minutes. After light was emitted from the light emitting unit 40 for 4 minutes, the concentration of the acetic butylene gas was reduced below 30 ppm. After 6 minutes, the concentration of the acetic butylene gas was reduced to about 10 ppm, and after 8 minutes, the concentration of acetic butylene gas was reduced below 10 ppm.

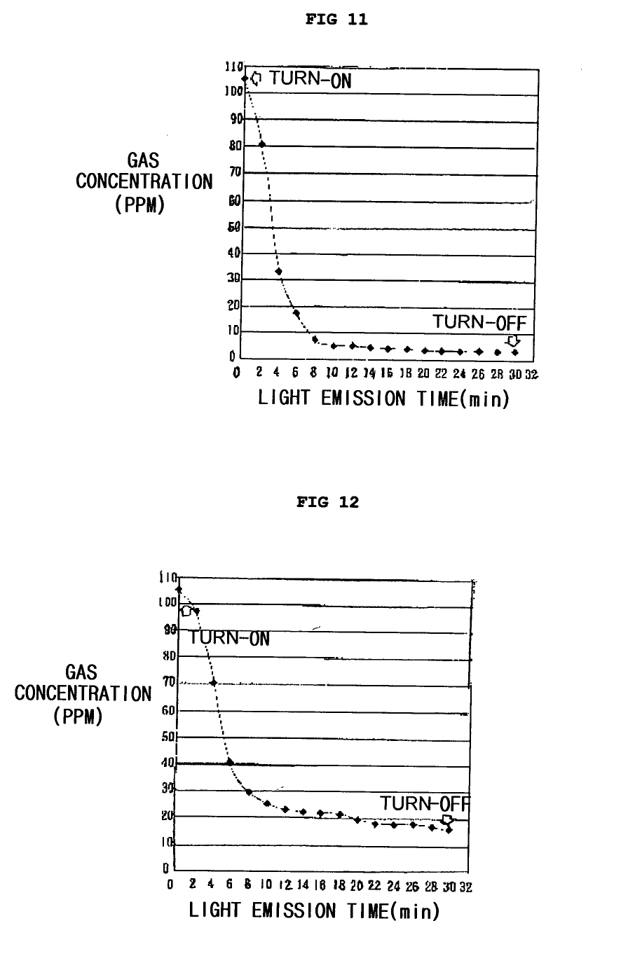

When the light emitting unit 40 of the lamp device emitted 356 nm wavelength light, the photocatalyst plate layer 10 catalyzes decomposition of the acetic butylene gas as shown in FIG. 11. Referring to FIG. 11, after light was emitted from the light emitting unit 40 for 4 minutes, the concentration of the acetic butylene gas was reduced to about 30 ppm. After 6 minutes, the concentration of the acetic butylene gas was reduced below 20 ppm, and after 8 minutes, the concentration of acetic butylene gas was reduced below 10 ppm.

When the light emitting unit 40 of the lamp device emitted 543 nm wavelength light, the photocatalyst plate layer 10 catalyzes decomposition of the acetic butylene gas as shown in FIG. 12. Referring to FIG. 11, after light was emitted from the light emitting unit 40 for 4 minutes, the concentration of the acetic butylene gas was reduced to about 70 ppm. After 6 minutes, the concentration of the acetic butylene gas was reduced to about 40 ppm, and after 8 minutes, the concentration of the acetic butylene gas was reduced below 30 ppm. That is, when light was emitted from the light emitting unit 40 for 4 minutes, the concentration of the acetic butylene gas was maximal when the light has a wavelength of 543 nm, and was minimal when the light has a wavelength of 254 nm. When light was emitted from the light emitting unit 40 for 6 minutes, the concentration of the acetic butylene gas was maximal when the light has a wavelength of 543 nm, and was minimal when the light has a wavelength of 254 nm. When light was emitted from the light emitting unit 40 for 8 minutes, the concentration of the acetic butylene gas was reduced below 10 ppm when the light has a wavelength of 365 nm or 254 nm. As the wavelength of the light emitted from the light emitting unit 40 was shorter, the acetic butylene gas was decomposed much faster. Furthermore, the final amount of the decomposed acetic butylene was greater when the wavelength of the light emitted from the light emitting unit 40 was 365 nm than when the wavelength of the light emitted from the light emitting unit 40 was 254 nm and 543 nm.

As described above, according to the OH radical air sterilization lamp quartz tube casing device of the present invention, the photocatalyst plate layer can have a large surface area, and the light emitting unit can be used for indirect illumination. Furthermore, heat generated from the light emitting unit circulates air around the light emitting unit by convection so that when the OH radical air sterilization lamp quartz tube casing device is used to sterilize air and decompose harmful gases contained in the air, an additional air circulation device is not required. In addition, since the fiber carrier is attached to the casing of the UV lamp, the UV lamp can be easily replaced with a new one, and it is not necessary to replace the fiber carrier when the UV lamp is replaced, thereby saving costs. Moreover, since the TiO₂ (sol) coated catalyst is formed around the separate casing, the present invention can be applied to various products. For example, the present invention can be used as a sterilization device capable of decomposing harmful gases in a dining room, a food processing factory, a pharmacy company, a hospital, a car, etc.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. An OH radical air sterilization lamp quartz tube casing device comprising:
a light emitting unit emitting UV light;
a casing formed of a quartz tube to enclose the light emitting unit;
a fiber carrier wrapped around the casing;
a catalyst plate layer formed on the fiber carrier and including pores allowing passage of air; and
a fixing member fixing the fiber carrier to the casing.

2. The OH radical air sterilization lamp quartz tube casing device of claim 1, wherein the catalyst plate layer is formed on the fiber carrier using a TiO₂ anatase sol by dipping the fiber carrier into the TiO₂ anatase sol and heat treating the fiber carrier to fix the TiO₂ anatase sol to the fiber carrier.

3. The OH radical air sterilization lamp quartz tube casing device of claim 1, wherein the catalyst plate layer is formed of at least one material selected from the group consisting of nano silver, nano ceramic sol, SiO₂, WO₃, SnO₂, Fe₂O₃, ZnO, Ag, and Pt.

4. The OH radical air sterilization lamp quartz tube casing device of claim 1, wherein the light emitting unit emits UV-A light having a wavelength of between about 320 nm to about 380 nm.

5. The OH radical air sterilization lamp quartz tube casing device of claim 1, wherein the casing is formed of an acryl tube including a polycarbonate (PC) tube or an polyvinyl chloride (PVC) tube to transmit UV-A light.

6. The OH radical air sterilization lamp quartz tube casing device of claim 1, wherein the fiber carrier is formed of a polyamide based material.

7. The OH radical air sterilization lamp quartz tube casing device of claim 1, wherein the fiber carrier is formed on a polyethylene based material.

8. The OH radical air sterilization lamp quartz tube casing device of claim 1, wherein the light emitting unit is a cold cathode fluorescent lamp (CCFL), an external electrode fluorescent lamp (EEFL), a light emitting diode (LED) or fluorescent lamp that emits UV-A light having a wavelength of 365 nm.

9. The OH radical air sterilization lamp quartz tube casing device of claim 1, wherein the light emitting unit is a cold cathode fluorescent lamp (CCFL), an external electrode fluorescent lamp (EEFL), a light emitting diode (LED) or fluorescent lamp that emits UV-C light having a wavelength of 180 nm to 280 nm.

10. The OH radical air sterilization lamp quartz tube casing device of claim 1, wherein the light emitting unit emits UV-C light having a wavelength of 254 nm.
